(19) United States
(12) Patent Application Publication
(10) Pub. No.: US 2022/0306857 A1
(43) Pub. Date: Sep. 29, 2022

(54) CARBON FIBER REINFORCED MOLDING COMPOSITION SUITABLE FOR ELECTROPHORETIC COATING

(71) Applicant: CONTINENTAL STRUCTURAL PLASTICS, INC., Auburn Hills, MI (US)

(72) Inventors: David J. Krug, III, Auburn Hills, MI (US); Nicholas T. Kamar, Auburn Hills, MI (US); Michael Z. Asuncion, Auburn Hills, MI (US); Steven L. Prascius, Auburn Hills, MI (US); MIchael J. Siwajek, Auburn Hills, MI (US)

(73) Assignee: Teijin Automotive Technologies, Inc., Auburn Hills, MI (US)

(21) Appl. No.: 17/635,464

(22) PCT Filed: Aug. 14, 2020
(86) PCT No.: PCT/US2020/046342

§ 371 Date: Feb. 15, 2022

Related U.S. Application Data
(60) Provisional application No. 62/887,264, filed on Aug. 15, 2019.

(51) Int. Cl. C08L 67/06; C08J 5/04; C09D 163/00

(52) U.S. Cl. CPC C08L 67/06; C08J 5/042; C09D 163/00; C08L 2205/04; C08L 2205/03; C08J 2475/02; C08J 2431/04; C08J 2467/06; C08J 2367/06; C08J 2331/04; C08K 2003/2241

(57) ABSTRACT

A cured article includes a cured thermoset resin matrix defining an article surface. Hollow glass microspheroids are dispersed in the cured thermoset resin matrix. A low profile additive package is dispersed in the cured thermoset resin matrix. A plurality of carbon fiber bundles are present and wet by the cured thermoset resin matrix. The matrix formed from a prepolymer and styrenic monomer. A free radical initiator is provided to cure the thermoset resin matrix and having limited decomposition products with a boiling point of between 160-210° C.; wherein the article emits less than 250 parts per million (ppm) of volatiles as measured after heating to 185° C. at a rate of 14° C./min and held for 1 minute.

### RELATED APPLICATIONS

This application claims priority benefit of US Provisional Application Ser. No. 62/887,264 filed 15 Aug. 2019; the contents of which are hereby incorporated by reference.

### FIELD OF THE INVENTION

The present invention in general relates to electrically conductive thermoset molding compound and methods of forming the same and in particular to dispersion of conducting fibers, and in particular carbon fibers in curable unsaturated thermoset resin that can be subjected to electrophoretic coating without resort to blistering or a prior heating to remove excess volatile organic content (VOC).

### BACKGROUND OF THE INVENTION

The use of fiber inclusions to strengthen a matrix is well known to the art. Well established mechanisms for the strengthening of a matrix include slowing and elongating the path of crack propagation through the matrix, as well as energy distribution associated with pulling a fiber free from the surrounding matrix material. In the context of sheet molding composition (SMC) formulations, liquid composite molding (LCM) and resin transfer molding (RTM) fiber strengthening has traditionally involved usage of chopped glass fibers.

There is a growing appreciation in the field of molding compositions that replacing in part, or all of the glass fiber in molding compositions with carbon fiber can provide improved component properties. The use of carbon fibers in composites, sheet molding compositions, and resin transfer molding (RTM) results in formed components with a lower weight as compared to glass fiber reinforced materials. The weight savings achieved with carbon fiber reinforcement stems from the fact that carbon has a lower density than glass and produces stronger and stiffer parts at a given thickness.

Weight savings in the auto, transportation, and logistics based industries has been a major focus in order to make more fuel efficient vehicles both for ground and air transport. Weight savings using carbon reinforced composites in vehicle parts has helped these industries achieve meaningful weight savings.

Electrostatic or electrophoretic coating of various vehicle components presents an attractive and cost-effective scheme as compared to usage of a conventional paint line. Electrostatic coating of vehicle parts, such as doors, hoods, quarter panels, and other vehicle skin parts can be routinely performed. Owing to the high visibility and environmental exposure encountered by such vehicle parts, a high-quality paint finish surface is demanded with a high degree of reflectivity and a surface free of visual defects. Electrostatic painting requires the part to be electrically conductive and support an electrical potential on the part needed to attract oppositely charged paint aerosol droplets to the part. Early attempts at producing inexpensive molding compound components amenable to electrostatic coating involved the application of an electrically conductive primer. With the primer application adding considerable cost and the primer application defects being manifest in the resulting painted article. As a result, these previous attempts to make sheet molding compound conductive articles were relegated to vehicle portions other than the vehicle skin, such as radiator brackets and wheel wells.

A highly carbon fiber filled SMC containing 40 to 60 volume percent of carbon fibers has been disclosed in the prior art in US Patent Application Publication 2013/0248241A1 in the context of a electromagnetic shielding. This composition was noted to be E-coat temperature capable, not because of addressing the failing of conventional formulation VOC content, but rather through replacing degassing resin during E-coating heating with carbon fiber. Additionally, the resulting article is expensive to produce, of limited strength due to voids associated with the wettability of fibers and not amenable to formulation modification as reducing the carbon fiber loading results in the reappearance of VOC degassing blistering during E-coat.

The development of an inherently conductive sheet molding compound obviates the need for the application of a conductive primer coat. Such a conductive sheet molding compound (SMC) is detailed in U.S. Pat. No. 6,001,919. As tolerances for the acceptable amount of SMC article shrinkage relative to mold specifications decreases, as well as increased demands as to painted surface finish attributes, low profile additives are increasingly found in SMC. Representative of these high-performance SMC formulations inclusive of low profile additives are those currently marketed by Continental Structural Plastics under the trade name TCA®. The inclusion of low profile additives is compatible with a conductive particulate to render an SMC article amenable to electrostatic painting, however, the inclusion of loadings of conductive particulate necessary to make an article sufficiently conductive, modifies the flow properties of the molding compound resins, leading to inhomogeneous molded articles, degrades the surface finish, and the higher viscosity forces molding filling conditions that degrade the conductivity of a given volume of conductive filler. While U.S. Pat. No. 7,655,297 details a formulation that achieves automotive surface high gloss finishes, however, with low density formulations loaded with glass hollow microspheroids surface finish degrades with the inclusion of conducting particulate.

An additional form of electrostatic or electrophoretic coating is referred to as the E-coat process that is necessary to protect metal components from corrosion. However, in automotive manufacturing reinforcement components and chassis related components are often a combination of metal and composite materials and are often referred to as body-in-white assemblies. During an E-coating process, the entire body-in-white assembly including any plastic and/or composite components goes through the coating bath. Electrical current in the bath ensure uniform coating on conductive metal components only. Thereafter, the body-in-white passes through a long oven tunnel. Temperatures can reach 215° C. and dwell times can be as long as 30-60 minutes or more. Volatiles in composite components, which can come from entrapped air, moisture, volatile organic compounds (VOCs), and other low boiling point compounds, can be rapidly expelled leading to ruptures commonly referred to as blisters in the composite portions of the body-in-white components or assemblies. Such defects are unrepairable and the whole component must be removed, scraped, and replaced adding material and time costs.

Thus, there exists a need for a molding compound composition that is conductive, has low VOCs, and is able to hold up to high temperatures associated with the E-coat process without defects and still provide a blister-free and otherwise high quality paint finish.

### SUMMARY OF THE INVENTION

A cured article includes a cured thermoset resin matrix defining an article surface. Hollow glass microspheroids are dispersed in the cured thermoset resin matrix. A low profile additive package is dispersed in the cured thermoset resin matrix. A plurality of carbon fiber bundles are present and wet by the cured thermoset resin matrix. The matrix formed from a prepolymer and styrenic monomer. A free radical initiator is provided to cure the thermoset resin matrix and having limited decomposition products with a boiling point of between 160-210° C.; wherein the article emits less than 250 parts per million (ppm) of volatiles as measured after heating to 185° C. at a rate of 14° C./min and held for 1 minute.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1A is a photographic view of an IR test oven with a composite test part;

FIG. 1B is a closeup view of FIG. 1A showing the composite panel under test;

FIG. 2A is a prior art photograph of conventional carbon fiber loaded sheet molding composition showing blistering after heating conditions associated with-coating; and

FIG. 2B is a photograph of an inventive formulation containing like amounts of carbon fiber showing no blistering after heating conditions used in FIG. 2A.

### DESCRIPTION OF THE INVENTION

The present invention has utility as a carbon fiber based molding compound suitable for use with extreme heat profiles experienced during the E-coat processes employed during vehicle manufacturing. The E-coat process is an electrophoretic coating process that is necessary to protect metal components from corrosion. However, the entire body-in-white assembly including any plastic and/or composite components is exposed to the coating bath. Electrical current in the bath ensure uniform coating on conductive metal components only. Thereafter, the body-in-white passes through a long oven tunnel in which temperatures can reach 215° C. and dwell times range from 30 to 60 minutes or even longer. Volatiles in composite vehicle components can be rapidly expelled leading to ruptures commonly referred to as blisters. The source of such blister entrapped air, moisture, VOCs, and other low boiling point compounds liberated under the conditions of E-coating. Such defects are unrepairable and the whole component assembly must be removed, scraped, and replaced adding unproductive material and labor costs.

The present invention achieves E-coat capability by addressing several sources of degassing. Many glass fiber SMC products are known to have adequate E-coat capability meaning the surface of the molded article does not blister during the E-coat process due to the high temperatures. The blisters are essentially a delamination of the composite from the off-gassing of compounds that volatilize under the heat conditions of the E-coat process, which can reach temperatures of 210° C. Although this seems straightforward, the root cause of the volatile induced delamination is not well understood. The present invention provides a carbon fiber reinforced SMC composite product that survives the harsh conditions of the E-coat process.

An E-coat capable carbon fiber sheet molding composition (CF-SMC) is provided herein. The key factors affording this breakthrough come from a formulation of the thermoset resin matrix driven by the careful consideration and reduction of potential volatiles. It has been surprisingly discovered that there are three main sources of potential volatiles that need to be minimized. In addition to sources listed below it is well known that moisture from atmospheric humidity conditions can greatly affect the occurrence of SMC blisters during E-coat. The boiling point of water (100° C.) is well below the maximum E-coat oven temperature and high levels of moisture can lead to large amounts of off-gassing especially given the fast ramp rates in E-coat ovens. Ramps rates can be as high as 30° C./min, and as a result, the water entrapped in the composite article volatilizes in a time period much shorter than what would be necessary for gradual non-destructive evolution out of the composite via diffusion. The same mechanism applies to all potential volatiles. A potential work around would be to reduce the ramp rate of the E-coat oven, but this is impractical industrially as slow heating compromises throughput and in actuality the opposite is the case with E-coat oven temperatures and ramps being maximized to increase throughput. Also, composites must be able to withstand the same conditions as automotive metal alloys, else such composites will be supplanted by metals.

The first of the three main sources of potential volatiles comes from entrapped air in the composite. Air can be introduced to the raw SMC during compounding by poor wet-out (impregnation) of carbon fiber tows. This leads to air containing voids in the molded article and upon heating to E-coat temperatures (up to 210° C.) the trapped gases expand causing delamination and blistering. One solution to poor fiber wet-out is to reduce the viscosity of the matrix for better fiber impregnation during SMC compounding. The matrix viscosity is often reduced by additives or additional styrene monomer. However, styrenic monomer itself can be a second main source of potential volatiles.

The boiling point of styrene is 145° C. and related aromatic free radical curing C₈₋₁₂ monomers are below the maximum E-coat oven temperature. Styrene monomer is the prototypical reactive diluent used to dissolve unsaturated polyester, vinyl ester, thermoplastic low profile additives, and many other processing aid additives. In some SMC formulations, styrene is the majority component of the organic portion of the matrix. Unreacted styrene in the molded article can be a large source of potential volatiles. Typically, amounts detected by gas chromatograph coupled to mass spectrometer (GC-MS) with a sample heated in thermal desorption chamber to mimic E-coat oven conditions that have above 200 parts per million (ppm) leads to a high occurrence of blisters.

One approach to minimizing residual styrenic monomer is the industrially impractical extension of dwell time in the mold or a post bake. These solutions are not viable due to increased energy consumption, decreased throughput, increased cost, and the requirement of additional capital equipment. Increasing molding temperatures can be counterproductive because it can lead to more rapid volatilization of styrenic monomers rather than polymerization, thereby leading to blistering during molding one intended to avoid in E-coating.

A more elegant solution is to optimize the polymerization kinetics by judicious selection of initiator(s). However, this seeming solution leads to a third source of potential volatiles: decomposition products. Organic peroxides are used as initiators for free radical polymerization of the unsaturated C═C bonds in the thermoset resins and styrene leading to a cross-linked network. The peroxide initiators undergo thermal decomposition to form radicals for polymerization. This thermal decomposition also creates byproducts. For example, tert-butylperoxy 2-ethylhexyl carbonate has three major decomposition products: carbon dioxide, tert-butanol, and 2-ethylhexanol. GC-MS of the molded article shows large amounts of 2-ethylhexanol, which has a boiling point of 180-186° C. The CF-SMC compounded with this initiator also blistered under E-coat process conditions. The same CF-SMC formulation compounded without this initiator was able to pass E-coat conditions without blistering.

The boiling points of these and other decomposition products are important. Blistering typically occurs between 160-210° C. or other maximum E-coat oven temperature. Decomposition products with boiling points between approximately 100 and 200° C. pose the greatest risk for blistering and E-coat failure. Compounds with lower boiling points can evolve out at room temperature or during slow initial heating in the oven. Compounds with higher boiling points evolve out slowly (or not at all) only at the maximum E-coat oven temperature during the dwell phase after the majority of other volatile have already escaped. This applies to byproducts found in the raw materials from their original manufacture as well as the products of side reactions.

Entrapped air, unreacted styrenic monomers, and decomposition related byproducts are each known alone to be undesirable in the prior art. It is the understanding and control of all three together synergistically that allows for the new invention of E-coat capable carbon fiber SMC according to the present invention.

In addition to the control and minimization of blister causing volatiles, the overall integrity of the polymer network forming the thermoset matrix of the composite should be considered. A more robust composite network with high inter-laminar shear strength, sufficient cross-link density, and optimal fiber-matrix adhesion would obviously tolerate more internal pressure from out-gassing volatiles. These factors however are considered in all SMC fabrication. Higher strength-to-weight ratios are always needed to reduce part weight and cost. Nonetheless, it is important to mention that resin blends leading to high cross-link densities, 4,000-8,000 mol/m³, and inter-laminar shear strength aid in the prevention of delamination. Good adhesion between the fibers and matrix via optimal sizing and coupling agents not only increases strength properties, but also reduces void space for the potential accumulation of volatile forming compounds.

In some inventive embodiments, a thickener is added to the uncured formulation to improve ease of handling. With resort to an alkaline earth oxide, alkaline earth hydroxide, or a combination thereof, a composition formulation is rendered more viscous under a given set of conditions relative to a like formulation lacking the thickener without the degree of degassing commonly seen with polyurea interpenetrating network thickeners commonly used for vinylester based CF-SMC. Without intending to be bound to a particular theory, it is believed that the polyurea breaks down under E-coat heating

Furthermore, the minimization of VOCs is a critical factor in preventing blistering. In some inventive embodiments, the total VOC content is less than 250 ppm (μg/g) in a cured inventive article, based on a standard calibration curve (toluene equivalents) while still retaining the carbon fiber that enhances the component properties and the molding resin handling properties of conventional thermoset SMC resins. Typical thickness of a molded article according to the present invention is between 1 and 10 mm. In some inventive embodiments, the inventive carbon fiber reinforced thermoset SMC formulations are compression moldable with short cycle times with SMC resins that cure at temperatures of between 140-160° C., and have the ability to flow and mold complex shapes.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The typical length of the chopped carbon fibers according to the present invention is between 10 and 50 mm.

Some inventive embodiments of the carbon fiber based molding formulation are also amenable to receiving a highly uniform paint or coating via electrostatic painting techniques. A low density molding compound formulation having a specific gravity of less than 1.65 and in some inventive embodiments, as low as 0.89 is provided that includes a thermoset cross-linkable unsaturated polyester, a low profile additive package containing a maleic anhydride copolymer, hollow microspheroids, and an amount of between 0.1 and 55 weight percent of carbon fibers, the formulation exclusive of non-carbon fiber fillers The carbon fibers are dispersed in at least one of the unsaturated polyester and the low profile additive to produce a cured panel having a surface resistivity value of between 0.0001Ω and 1Ω.

A process for producing such a molding compound panel includes dispersing the carbon fiber bundles in the molding formulation and curing the thermoset components in the shape of a desired article through contact with a mold platen. In some inventive embodiments, the complete, uncured formulation flows having a molding viscosity. Viscosities of between 10 and 50 million Centipoise are especially desirous to promote handling in a production setting. The resulting article is amenable to direct e-coating with the elevated temperatures associated therewith and without resort to a conductive priming step. Inventive formulations for the production of an inventive article amenable to e-coating without surface blistering is provided in Table 1.

TABLE 1
Typical and preferred ranges of components in an inventive formulation, in which
values are provided in total weight percentages including carbon fiber.

| | Typical Total | Preferred Total |
|---|---|---|
| | Weight Percent | Weight Percent |
| Reactants | | |
| Cross-linkable unsaturated polyester and/or | 5-remainder | 6-remainder |
| vinylester resin | | |
| Ethylenically unsaturated monomer | 4-50 | 6-30 |
| (e.g. styrene) | | |
| Reaction Kinetic Modifiers | | |
| Free radical initiation (e.g. peroxide/ | 0-3 | 0.1-1 |
| peroxy ketals, or azo compounds) | | |
| Polymerization inhibitor (e.g., | 0-2 | 0.1-1 |
| hydroquinone) | | |
| Additives | | |
| Mold release (e.g., stearate additive) | 0-5 | 0.2-3 |
| Plasticizer | 0-3 | 0.1-0.5 |
| Thickeners | 0-5 | 0.5-3 |
| Colorants | 0-3 | 0.1-1 |
| Flame retardant | 0-3 | 0.1-0.7 |
| Thickeners | 0-5 | 0.5-2.5 |
| Colorants | 0-3 | 0.1-1 |
| Fillers | | |
| Particulate filler (e.g., calcium carbonate | 0-25 | 1-15 |
| or alumina) | | |
| Glass microspheroids | 0-15 | 0-10 |
| Chopped carbon fiber bundles | 30-70 | 45-65 |
| Low Profile Additive (LPA) Package | 5-40 | 7-20 |

A base conductive SMC formulation that benefits from incorporation of conductive carbon fiber includes a wide variety of thermoset SMC components. While a variety of base SMC formulations are known such as those described in U.S. Pat. Nos. 4,260,538; 4,643,126; 5,100,935; 5,268,400; 5,854,317; 6,001,919; and 6,780,923; and all of these formulation benefit from the inventive process of controlled carbon fiber dispersion to render a resulting cured article formed therefrom amenable to e-coat processing. The typical amounts of components in an inventive composition are provided in Table 1

A principal component of a mold compound formulation is an unsaturated polyester resin cross-linkable polymer resin. The prepolymer polymeric resin has a molecular weight on average of typically between 400 and 100,000 Daltons. The polyester prepolymer resins typically represent condensation products derived from the condensation of unsaturated dibasic acids and/or anhydrides with polyols. It is appreciated that the saturated di- or poly-acids are also part of the condensation process to form polyester prepolymers with a lesser equivalency of reactive ethylenic unsaturation sites. Unsaturated polyester resins disclosed in U.S. Pat. No. 6,780,923 are preferred for use with the present invention.

As used herein, “unsaturated” refers to covalent bond attachment to the carbon atoms of a carbon-carbon bond being less than a maximal complement of bonding carbon or hydrogen atoms, namely the carbon-carbon bond is a double or triple bond.

The polymeric resin prepolymer is suspended, and preferably dissolved, in an ethylenically unsaturated monomer that copolymerizes with the resin during the thermoset process. It is appreciated that more than one type of monomer can be used in a molding compound. The monomer provides benefits including lower prepolymer viscosity and thermosetting without formation of a volatile byproduct. Ethylenically unsaturated monomer operative herein illustratively includes styrene, alpha-methylstyrene, vinyltoluene, chlorostyrene, (meth)acrylic acid, alkyl (methyl)acrylates, acrylonitrile, vinyl acetate, allyl acetate, triallyl cyanurate, triallyl isocyanurate, and acrylamide. Styrene and methyl methacrylate are especially preferred. A normally solid polymerizable monomer such as diacetone acrylamide is optionally used as a solution in one of the above-recited normally liquid polymerizable monomer.

A typical molding compound includes a free radical initiator to initiate cross-linking between the polymeric prepolymer resin with itself or with ethylenically unsaturated monomer, if present. A free radical initiator is typically chosen to preclude significant cross-linking at lower temperature so as to control the thermoset conditions. Conventional free radical polymerization initiators contain either a peroxide or azo group. Peroxides operative herein illustratively include benzoyl peroxide, cyclohexanone peroxide, ditertiary butyl peroxide, dicumyl peroxide, tertiary butyl perbenzoate and 1,1-bis(t-butyl peroxy) 3,3,5-trimethylcyclohexane. Azo species operative herein illustratively include azobisisobutyronitrile and t-butylazoisobutyronitrile. While the quantity of free radical polymerization initiator present varies with factors such as desired thermoset temperature and decomposition thermodynamics, an initiator is typically present from 0.1 to 3 total weight percent. In order to lessen cross-linking at temperatures below the desired thermoset temperature, a polymerization inhibitor is often included in base molding formulations. Hydroquinone and t-butyl catechol are conventional inhibitors. An inhibitor is typically present between 0 and 1 total weight percent. Collectively, a polymerization initiator and a polymerization inhibitor, to the extent these are present are selected to contribute less than 100 ppm of decomposition products with a boiling point of between 160-210° C.

The inventive molding compound in some inventive embodiments includes a nonconductive particulate filler. Non-conductive particulate fillers operative in such molding compounds illustratively include hollow glass microspheroids, calcium carbonate, calcium silicate, alumina, alumina trihydrate (ATH), silica, talcs, dolomite, vermiculite, diatomaceous earth, kaolin clay, and combinations thereof. Factors relevant in the choice of a particulate filler illustratively include filler cost, resultant viscosity of flow properties, resultant shrinkage, surface finish weight, flammability, and chemical resistance of the thermoset formulation. Typical filler sizes are from 0.1 to 50 microns. It is appreciated that glass microspheres are preferable surface derivatized in applications where high performance is required. Surface derivatized microspheroids are detailed in U.S. Pat. No. 7,700,670; and US Patent Publication 2015/0376350 A1.

In some inventive embodiments, the surface activating agent molecules covalently bonded to the microspheroid surface have a terminal reactive moiety adapted to bond to a surrounding resin matrix during cure. Without intending to be bound to a particular theory, covalent bonding between a cured resin matrix and the microspheroid increases the delamination strength of the resulting SMC in tests such as ASTM D3359. As used herein, the weight percent of a microspheroid covalently bonded to a surface activating agent is intended to include the weight of the surface activating agent.

A terminal reactive moiety that is reactive with an SMC resin during cure illustratively includes a tertiary amine-; hydroxyl-; imine-; an ethylenic unsaturation, such as an allyl- or acryl-; or cyano-moiety. It is appreciated that matrix cure can occur through mechanisms such as free radical cure, moisture cure, and combinations thereof.

Tertiary amine terminated thermoplastic are readily prepared. D. H. Richards, D. M. Service, and M. J. Stewart, Br. Polym. J. 16, 117 (1984). A representative tertiary amine terminated thermoplastic is commercially available under the trade name ATBN 1300 X 21 from Noveon.

A surface activating agent molecule that bonds to a glass microspheroid is an alkoxysilane where the silane is reactive with the silica surface of the microspheroid. Representative alkoxysilane surface activating agents for the microspheroid illustratively include: 3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, (3-glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, methacryloxypropyltrimethoxysilane ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof. In certain inventive embodiments, the alkoxysilane surface activating agent includes an ethylenically unsaturated moiety that is reactive under free radical cross-linking conditions so as to covalently bond the microspheroid surface to the surrounding resin matrix.

Alternatively, it is appreciated that microspheroid surface activating agent is readily mixed into the pre-cured SMC formulation and hollow glass microspheres added thereto to induce microsphere activation prior to initiation of matrix cure. Typically, the surface activating agent is present in concentrations of about 0.05 to 0.5 grams of surface activating agent per gram of microspheroids.

Aside from chopped carbon fiber bundles, fiber filler is typically added to provide strength relative to a particulate filler. Fiber fillers operative herein illustratively include glass, carbon nanotubes, polyimides, polyesters, polyamides, and natural fibers such as cotton, silk, and hemp. Typical fiber filler lengths range from 5 to 50 millimeters.

A mold release agent is typically provided to promote mold release. Mold releases include fatty acid salts illustratively including oleates-, palmitates-, stearates- of metal ions such as sodium, zinc, calcium, magnesium, and lithium. A mold release is typically present from 0 to 5 total weight percent.

A low profile additive is optionally provided to improve surface properties and dimensional stability of a resulting molded product. In contrast to U.S. Pat. No. 7,655,297; low profile additives of polyethylene, polyacrylates are preferential replaced entirely or at least 50% by weight is with LPAs that illustratively include thermoplastics such as polystyrene, polymethylmethacrylate, polyvinylacetate, polycarbonate, or combinations thereof; and copolymers including butadiene, acrylonitrile, and vinyl chloride and specifically include styrene butadiene rubbers. Preferably, a mixture of thermoplastic and elastomeric LPAs are present. It is appreciated that the present invention optionally also incorporates additional additives illustratively including flame retardants, plasticizers, colorants, and other processing additives conventional to the art.

A maleated polymer is present in some inventive embodiments as part of the LPA package and is characterized by a graft polymer in which maleic anhydride is graft copolymerized with a polymer. Maleated polymers operative in the present invention illustratively include a maleic anhydride grafted copolymer of styrene, polypropylene, maleated polyethylene, maleated copolymers or terpolymers of propylene containing acrylate and maleate, maleic anhydride grafted polystyrene, and combinations thereof. In some inventive embodiments, the degree of maleation is between 0.1 and 5 maleic anhydride content as weight percent of the maleated polymer. In other inventive embodiments, the degree of maleation is between 1 and 4 weight percent of the maleated polymer and most preferably between 1 and 2 weight percent. Typically, a maleated polymer is present in an inventive formulation in an amount of between 0.1 and 8 total weight percent and preferably between 1 and 3 total weight percent.

For molding compounds of the present invention to be well suited for the rapid production of molded composite articles that have a high gloss finish as measured by ASTM D523 inclusive of an electrostatic paint coating, a high surface area conductive carbon black particulate is mixed into a single side or multiple side of a compound formulation under conditions that satisfy expression (I) and upon mixing all the side and fiber filler results in a molding viscosity of between 30 and 50 million Centipoise.

The present invention is particularly well suited for the production of a variety of vehicle panel products illustratively including bumper beams, fenders, vehicle door panel components, automotive floor components, spoilers, hoods, and engine cradles; and various industrial and consumer product housings.

The present invention is further detailed with respect to the following non-limiting examples. These examples are not intended to limit the scope of the appended claims.

### EXAMPLES

### Comparative Example A

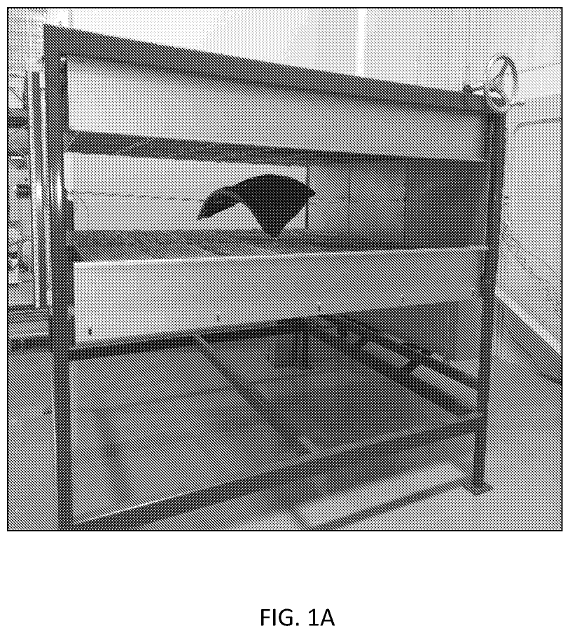

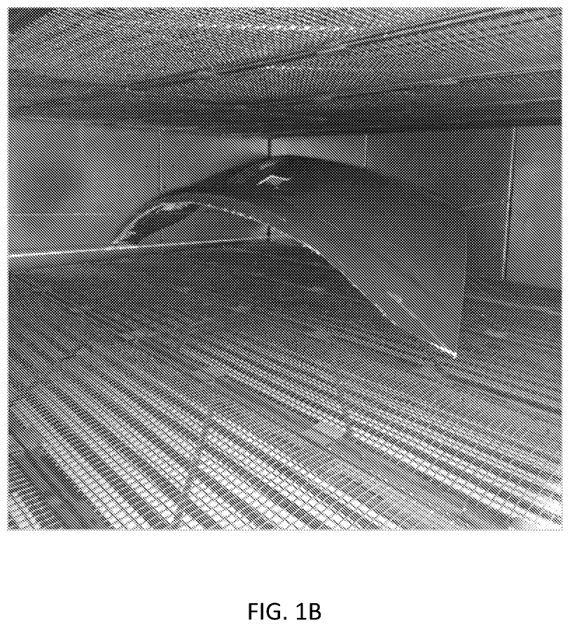

The resulting composite materials incorporated into body-in-white structures must be able to survive the harsh conditions of the E-coat oven. An E-coat simulation test can be run in the lab on molded flat panels or production parts with a specially designed infrared oven. To test E-coat capability, the samples produced in Comparative Examples A-C, and 1-3 are subjected to a temperature ramp as a function of time in air. Test samples are suspended in the oven between an upper and a lower bank of infra-red (IR) heating elements as shown in FIGS. 1A and 1B. Thermocouples connected to the specimen surface relay part surface temperature to a computer, which is programmed with a heat profile collected from the actual manufacturer's E-coat oven. The result is a very accurate simulation of the real world E-coat oven heat profile. A composite material passes the E-coat simulation if no blisters form that are visible to a normal, unaided human eye.

A VOC analysis method was used to determine if a composite material will be able to undergo E-coat without suffering blistering is as follows:

Samples are heated to 185° C. at a rate of 14° C./min and held for 1 minute, which are conditions that mimic commonly used E-coat heating profiles Volatiles are trapped, thermally desorbed, and injected into a GC/MS for analysis. Concentrations are given in ppm (μg/g) based on a standard calibration curve (toluene equivalents).

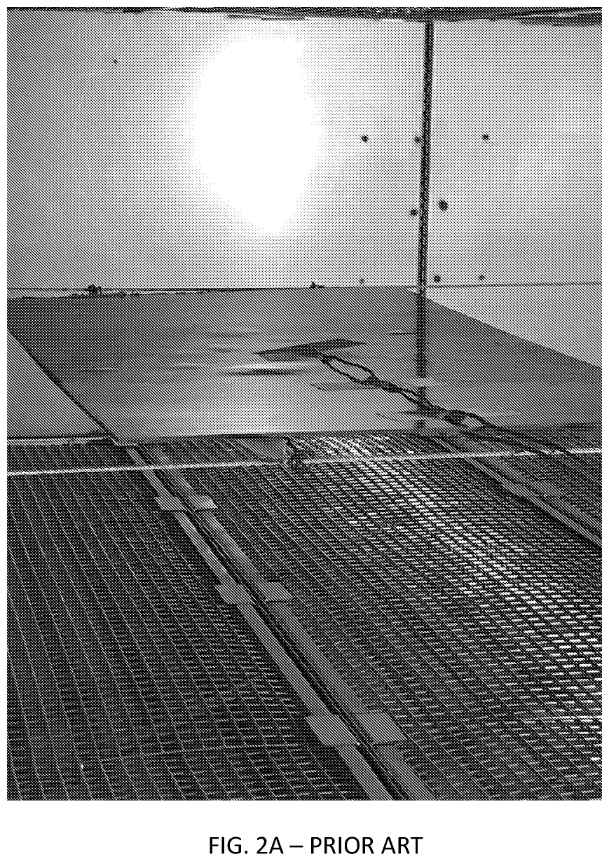

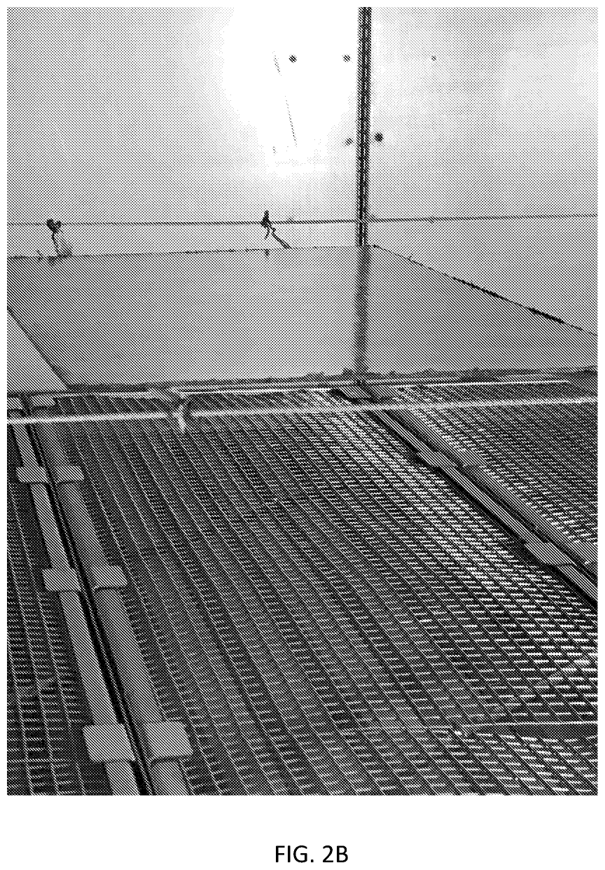

A conventional formulation, consisting of vinyl ester cross-linked with styrene, low profile additive, and thickened in part by an interpenetrating polymer (polyurea) network and is not E-Coat capable. The resulting cured composite is tested as detailed above and had a measured VOC content of 625 ppm as measured in the above test protocol. A photograph of the resulting composite has observed blistering to an unaided, normal human eye is shown in FIG. 2A.

### Example 1

The formulation is modified to include a blend of unsaturated polyester and vinyl ester cross-linked with styrene, low profile additive, and thickened by MgO. The resulting cured composite is tested as detailed above and had a measured VOC content of 236 ppm as measured in the above test protocol. A photograph of the resulting composite shows observed blistering to an unaided, normal human eye is shown in FIG. 2B.

### Example 2

The article of Example 1 is e-coated by dipping into a cathodic E-coat bath solution (water 71-82 wt. %, epoxy resin 16-26 wt. %, titanium dioxide 1.3 wt. %) for 40 seconds of time and slowly pulled out of the solution at a steady rate. Curing of the coating is performed in an oven at 171-C for 25 min.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A cured article comprising:
a cured thermoset resin matrix defining an article surface;
hollow glass microspheroids dispersed in said cured thermoset resin matrix;
a low profile additive package dispersed in said cured thermoset resin matrix; and
a plurality of carbon fiber bundles wet by said cured thermoset resin matrix;
styrenic monomer cured into and part of said cured thermoset resin matrix; and
free radical initiator curing said cured thermoset resin matrix and having limited decomposition products with a boiling point of between 160-210° C.; wherein the article emits less than 250 parts per million (ppm) of volatiles as measured after heating to 185° C. at a rate of 14° C./min and held for 1 minute.

2. The article of claim 1, wherein said cured thermoset resin matrix is a polyester.

3. The article of claim 1 wherein said hollow glass microspheroids further comprise a silane surface derivative bonded to said matrix.

4. The article of claim 1 wherein said hollow glass microspheroids are present from 5 to 15 total weight percent.

5. The article of claim 1 wherein said low profile additive package further comprises at least one of polystyrene, styrene-butadiene rubber, polyvinyl acetate, or polyethylene.

6. The article of claim 1 wherein said styrenic monomer is styrene present in an amount that contributes less than 200 ppm of the volatiles.

7. The article of claim 1 further comprising a thickener, said thickener being an alkaline earth oxide, an alkaline earth hydroxide, or a combination thereof.

8. The article of claim 7 wherein said thickener and the article are devoid of polyurea interpenetrating network.

9. The article of claim 7 further comprising an e-coating applied to the article surface, said e-coating being free of blisters visible to an unaided, normal human eye.

10. The article of claim 1 further comprising an e-coating applied to the article surface, said e-coating being free of blisters visible to an unaided, normal human eye.

11. The article of claim 8 further comprising an e-coating applied to the article surface, said e-coating being free of blisters visible to an unaided, normal human eye.
